(19) United States
(12) Patent Application Publication
(10) Pub. No.: US 2002/0131369 A1
(43) Pub. Date: Sep. 19, 2002

(54) Traffic monitoring method and traffic monitoring system

(75) Inventors: Tooru Hasegawa, Saitama (JP); Shigehiro Ano, Saitama (JP); Kouji Nakao, Saitama (JP); Toshihiko Katou, Saitama (JP)

Correspondence Address: ARMSTRONG,WESTERMAN & HATTORI, LLP, 1725 K STREET, NW., SUITE 1000, WASHINGTON, DC, 20006, US

(73) Assignee: KDDI Corporation, Tokyo (JP)

(21) Appl. No.: 10/092,436

(22) Filed: Mar. 8, 2002

(30) Foreign Application Priority Data
Mar. 19, 2001 (JP) 2001-78712

(51) Int. Cl. H04J 1/16

(52) U.S. Cl. 370/241; 370/229

(57) ABSTRACT

A traffic monitoring system enabling a manager to manage a plurality of traffic monitors in a centralized manner with a desired specification and to effectively utilize a traffic analysis result of each traffic monitor for network management is provided. The manager 1 loads a management application program to the manager itself and executes the program (S1). The manager 1 transfers the management application program to each active monitor 2 to allow the management application program to be executed (S2 and S3). Each active monitor 2 provides an analysis result to the manager 1 in response to a request (S4) from the manager 1 (S5). Each active monitor 2 stops a packet analysis program in response to a request (S6) from the manager 1 and unloads the packet analysis program. After collecting the analysis result, the manager 1 stops and unloads the management application program (S8).

### BACKGROUND OF THE INVENTION

1. Field of the Invention

The present invention relates to a traffic monitoring method and a traffic monitoring system. More particularly, the present invention relates to a traffic monitoring method and a traffic monitoring system including a plurality of active monitors each tapping a physical line on a network and analyzing traffic, and a manager collecting an analysis result of each of the active monitors and managing the traffic.

2. Description of the Related Art

In a packet network such as the Internet, RMON (Remote network Monitoring) MIB (Management Information Base) or a traffic monitor is employed for detecting a fault, such as congestion or abnormal traffic, which deteriorates the performance and reliability of the network and estimating the cause of the fault.

(1) RMON MIB

RMON MIB is a network management system in which a manager serving as a management unit collects traffic information acquired by remote traffic measurement equipment (RMON).

RMON taps physical lines and observes packets to thereby measure the number of packets, the number of error packets or the number of broadcasts flowing on the network, and stores the measurement result as RMON MIB. The observation result stored in the RMON MIB can be transferred from the RMON to the manager by means of the SNMP (Simple Management Protocol).

A network administrator or a network management system can manage the network based on the traffic information acquired from many RMON.

(2) Traffic Monitor

A traffic monitor taps physical lines on the packet network to observe packets and stores the observed packets or headers as part of the observed packets. A string of packets thus stored can be read offline afterwards and can be used for protocol analysis or the calculation of traffic such as the calculation of the number of packets. As the traffic monitor, a product such as Sniffer or a public domain software such as tcpdump exists.

If the performance fault of the network or abnormal traffic such as DOS (Denial of Service) occurs, the network administrator manually analyzes traffic information stored in the traffic monitor and estimates a path to which the performance fault or the abnormal traffic occurs or a cause thereof.

However, the conventional techniques stated above have the following disadvantages.

(1) Disadvantages of RMON MIB

According to the RMON MIB, only information on traffic such as the number of packets can be acquired. The manager cannot analyze individual communication packets and protocols. For these reasons, even if the RMON MIB acquires the information, the behaviors of individual communication protocols and a performance fault derived from network congestion cannot be detected.

(2) Disadvantages of traffic monitor

Since the traffic monitor simply stores observed packets, it cannot store packet strings exceeding a disk capacity. For example, if a line at a rate of 2.4 G bps is monitored, even a disk having a storage capacity of 100 GB can store packets only for about 300 seconds. Due to this, the traffic monitor cannot observe packets for a long period of time and it is difficult to apply the observation result of the traffic monitor to network management.

Furthermore, differently from the RMONMIB, the traffic monitor does not include a function of transferring the observation result over the network. Due to this, many traffic monitor observation results cannot be collected by the manager and cannot be applied to network management.

Moreover, since the analysis of stored packets cannot be automatically performed by the traffic monitor, it is required to manually analyze all the stored packets.

(3) Disadvantages common to RMON MIB and traffic monitor

According to both the RMON MIB and the traffic monitor, a packet observation processing is incorporated in a hardware or a software. For this reason, it is necessary to change software or hardware so as to perform a packet observation processing and a packet analysis processing to meet a new demand. Besides, the software or hardware cannot be changed while the RMON or the traffic monitor executes these processings.

### SUMMARY OF THE INVENTION

It is an object of the present invention to provide a traffic monitoring method and a traffic monitoring system enabling a manager to manage a plurality of traffic monitors in a centralized manner with a desired specification and to effectively utilize traffic analysis results of the traffic monitors for network management.

To attain the above-stated object, the present invention provides a traffic monitoring system including: a plurality of active monitors each tapping a physical line on a network and analyzing traffic; and a manager collecting analysis results from the active monitors, respectively, the system characterized by including the steps of: allowing the manager to load and execute a management application program; allowing the manager to issue a request to the active monitors to load a traffic analysis program; allowing the active monitors to load and execute the traffic analysis program in response to the load request; allowing the manager to issue a request to the active monitors to collect analysis results; and allowing the active monitors to provide the analysis results to the manager in response to the request, respectively.

According to the above-stated features, the manager can dynamically load and unload a desired packet analysis program to and from each active monitor. It is, therefore, possible to execute an optimum packet analysis program or the latest packet analysis program on each active monitor in accordance with a monitoring content or a monitoring method.

Furthermore, since the management application program can be dynamically loaded and unloaded to and from the manager, it is possible to execute an optimum management application program or the latest management application program on the manager in accordance with a monitoring content or a monitoring method.

### BRIEF DESCRIPTION OF THE DRAWINGS

FIG. 1 is a diagram showing a network configuration to which a traffic monitor according to the present invention is applied;

FIG. 2 is a block diagram showing the configurations of the important parts of a manager and an active monitor;

FIG. 3 is a sequence diagram showing the active monitor control sequence of the manager;

FIG. 4 shows examples of topology information; and

FIG. 5 shows a topology information management method.

### DETAILED DESCRIPTION OF THE PREFERRED EMBODIMENT

One preferred embodiment of a traffic monitor according to the present invention will be described hereinafter in detail with reference to the drawings.

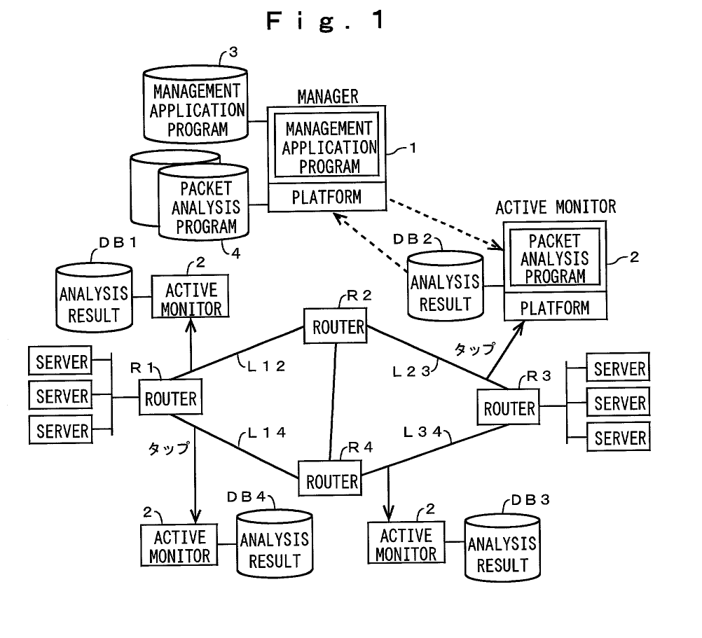

FIG. 1 shows a network configuration to which the traffic monitor of the present invention is applied. The network configuration includes a plurality of active monitors 2 which observe the traffic of physical lines and a manager which collects analysis results of these active monitors 2 and manages the network.

Each of the active monitors 2 taps physical lines L12, L23, L34 and L14 connecting routers R1, R2, R3 and R4, analyzes a packet or a protocol, and stores the packet or a header which forms a part of the packet in a analysis result database (DB).

Each active monitor 2 has not only an ordinary function (platform) which any conventional active monitor has but also a function of loading and executing a packet analysis program P2 downloaded from the manager 1.

A disk device 3 storing a management application program P1 and a disk device 4 storing the packet analysis program P2 are connected to the manager 1.

The manager 1 has not only an ordinary function which any conventional manager has but also a function of managing the respective active monitors 2 by loading and executing the management application program P1.

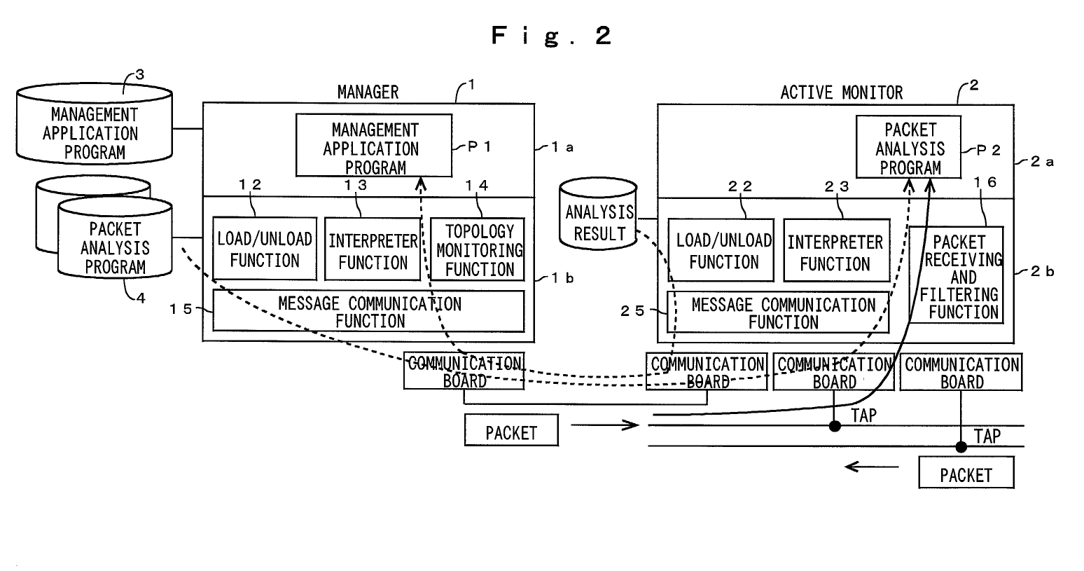

FIG. 2 is a block diagram showing the configurations of the important parts of the manager 1 and each active monitor 2.

The manager 1 consists of a storage section la which stores the management application program P1 dynamically loaded from the disk device 3 and a platform 1b. The active monitor 2 consists of a storage section 2a which stores the packet analysis program P2 dynamically loaded from the disk device 4 through the manager 1 and a platform 2b. The management application program P1 and the packet analysis program P2 are executed on the platforms 1b and 2b, respectively.

The manager 1 and each active monitor 2 has five characteristic functions as those of a traffic monitoring system as follows:

(1) Each active monitor 2 dynamically loads the packet analysis program P2 from the manager 1 and executes the program P2.

(2) The manager 1 dynamically loads the management application program P1 from the disk device 3 and executes the program P1.

(3) The manager 1 controls the packet analysis program P2 of each active monitor 2.

(4) Each active monitor 2 provides a packet filtering function to the packet analysis program P2.

(5) The manager 1 manages network topology.

The respective functions (1) to (5) will be described concretely.

(1) The active monitor 2 uses, as the language of the packet analysis program P2, a language such as Java which can be executed using the interpreter function 23 of the active monitor 2 so that the analysis program P2 for a packet or a protocol can be dynamically loaded from the manager 1 and then executed.

On the platform 2b of the active monitor 2, the interpreter function 23 analyzes and executes the packet analysis program P2 using a byte code interpreter such as Java. As the program language, Tel, Pascal, Smalltalk-80 or the like can be used in addition to Java.

The dynamic load and unload of the packet analysis program P2 are realized by inputting and outputting a class file serving as a program for Java or the like to and from the interpreter function section 23, respectively by the load/unload function 22.

(2) The manager 1 uses, as the language of the management application program P1, a language such as Java which can be executed using the interpreter function 13 of the manager 1 so that the management application program P1 managing each active monitor 2 can be dynamically loaded and executed.

On the platform 1b of the manager 1, the interpreter function 13 analyzes and executes the management application program P1 and a load/unload function 12 loads and unloads the management application program P1.

(3) The manager 1 and each active monitor 2 act as a client and a server in client-server model RPC (Remote Procedure Call) communications, respectively so that the manager 1 can control the packet analysis program P2 of each active monitor 2. RPC has three functions, i.e., “load and start of the packet analysis program P2”, “stop and unload of the packet analysis program P2” and “acquisition of analysis results”. The PRC is realized by message communication functions 15 and 25 on the respective platforms 1b and 2b.

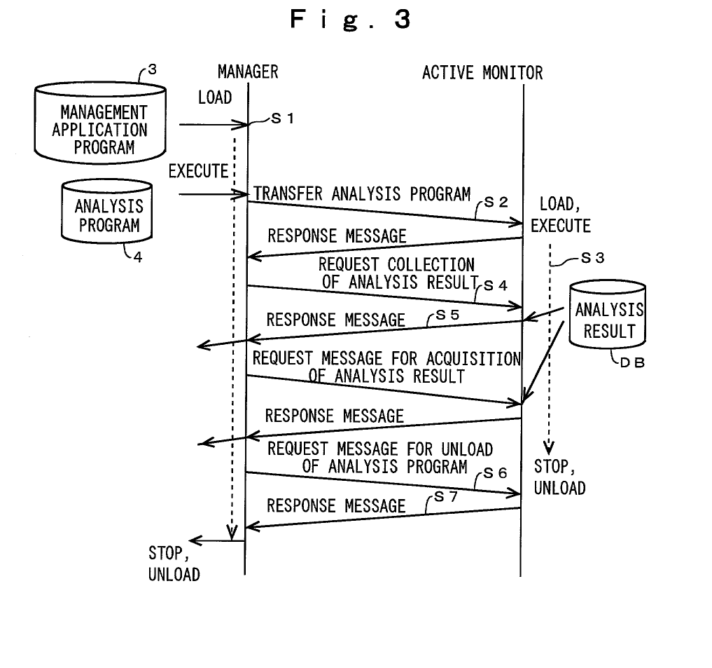

FIG. 3 shows a control sequence in which the manager 1 controls each active monitor 2. In this embodiment, an individual RPC such as “load and unload” is realized by a combination of a request message and a response message. In addition, TCP/IP is used for the transfer of messages.

In FIG. 3, first, the manager 1 loads the management application program P1 from the disk device 3 to the manager 1 itself and starts executing the program P1 (in S1). The management application program P1 of the manager 1 transfers a predetermined packet analysis program P2 stored in the disk device 4 to each active monitor 2 using a message communication protocol (in S2).

Each active monitor 2 loads the packet analysis program P2 transferred thereto to the active monitor 2 itself and starts executing the program P2 (in S3). An analysis result acquired by executing the packet analysis program P2 is stored in the analysis result DB.

If the management application program P1 of the manager 1 requests to collect the analysis result stored in each active monitor 2 using the message communication protocol (in S4), the active monitor 2 provides the analysis result stored in the analysis result DB to the manager 1 in response to the request (in S5).

When the collection of the analysis results is completed, the manager 1 requests each active monitor 2 to stop/unload the packet analysis program P2 using the message communication protocol (in S6). Each active monitor 2 stops and unloads the packet analysis program P2 in response to this request and outputs a response message (in S7).

If detecting the response message from each active monitor 2, the manager 1 stops the management application program P1 and unloads the program P1 (in S8). (4) On the platform 2b of each active monitor 2, a packet receiving and filtering function 16 provides a packet receiving function and a packet filtering function as an API (Application Program Interface) so that the packet analysis program P2 can analyze the packet and protocol observed by tapping the physical lines.

If a packet satisfying preset packet filtering conditions is observed, the packet receiving function notifies the packet analysis program P2 of the packet thus observed. The packet filtering function can set an originator IP address, a recipient IP address, a transmitting port number and a receiving port number as parameters for identifying observation target packets.

(5) The topology monitoring function 14 on the platform 1b of the manager 1 manages topology information including the addresses and locations of the active monitors 2 arranged to be distributed. Further, the topology monitoring function 14 provides the topology information as API to the management application program P1 on the manager 1. As a result, the management application program P1 of the manager 1 can analyze the performance of the entire network using a combination of the analysis results of the active monitors 2 and the network topology information.

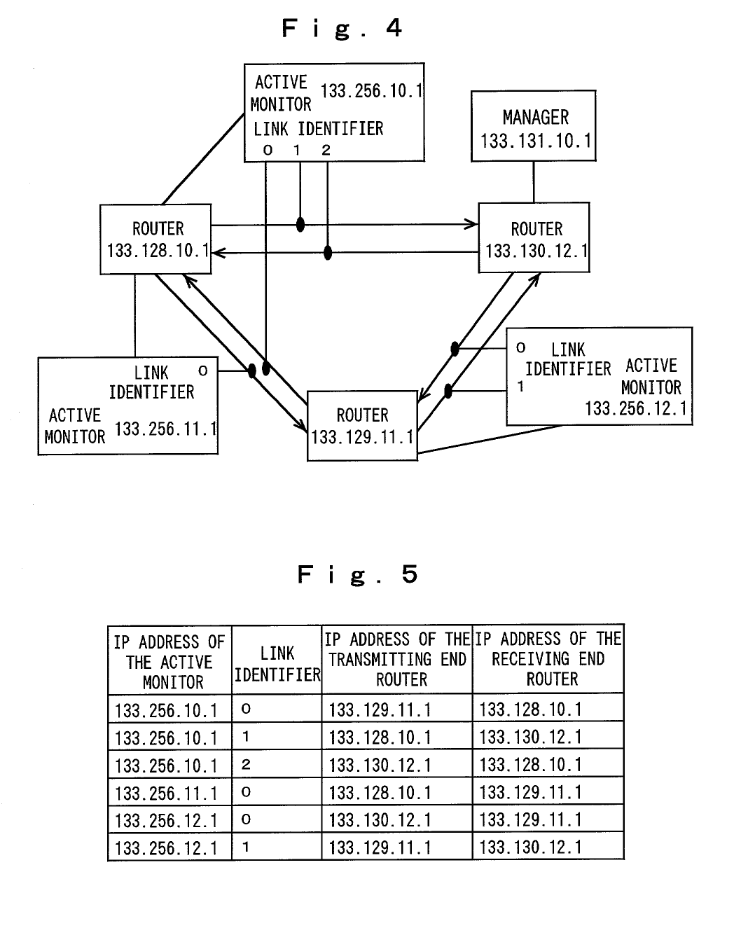

As shown in FIG. 4, in the topology information, the network monitored by the active monitors 2 is represented by a graph with the respective routers set as vertexes. Links between the routers are expressed by directed segments including information on the respective directions. The topology information shown in FIG. 4 is managed by a format shown in FIG. 5.

In this embodiment, one active monitor 2 can tap a plurality of physical lines. The physical line between the routers in one direction is identified by a combination of the identifier of the active monitor 2 (IP address) and a univocal link identifier in the active monitor 2. In addition, the physical line between the routers in the other direction is expressed by the IP addresses of the transmitting end router and the receiving end router.

As stated above, according to this embodiment, the manager 1 can dynamically load and unload the packet analysis program P2 to and from each active monitor 2. It is, therefore, possible to easily execute an optimum packet analysis program or the latest packet analysis program on each active monitor in accordance with a monitoring content or a monitoring method.

Furthermore, according to this embodiment, it is possible to dynamically load and unload the management application program P1 to and from the manager 1. It is, therefore, possible to easily execute an optimum management application program P1 or the latest management application program P1 on the manager 1 in accordance with a monitoring content or a monitoring method.

Additionally, according to this embodiment, the manager 1 can collect analysis results from the respective active monitors 2 at desired timing. Therefore, each active monitor 2 can dispense with a large-capacity storage means for storing data in large quantities.

As set forth above, the present invention has the following advantages.

(1) The manager can dynamically load and unload the packet analysis program to and from each active monitor. It is, therefore, possible to easily execute an optimum packet analysis program or the latest packet analysis program on each active monitor in accordance with a monitoring content or a monitoring method.

(2) It is possible to dynamically load and unload the management application program to and from the manager. It is, therefore, possible to easily execute an optimum management application program or the latest management application program on the manager in accordance with a monitoring content or a monitoring method.

(3) The manager can collect analysis results from the respective active monitors at desired timing. Therefore, each active monitor can dispense with a large-capacity storage means for storing data in large quantities.

What is claimed is:

1. A traffic monitoring system comprising: a plurality of active monitors each tapping a physical line on a network and analyzing traffic; and a manager collecting analysis results from said active monitors, respectively, wherein said manager comprises:
means for loading a management application program for managing the respective active monitors to the manager itself;
means for executing said management application program;
means for delivering a traffic analysis program to each of said active monitors; and
means for communicating with said active monitors, each of said active monitors comprises:
means for loading the traffic analysis program delivered from said manager to the active monitor itself;
means for executing said traffic analysis program; and
means for communicating with said manager, and wherein each of said active monitors provides a traffic analysis result to said manager through said communication means in response to a request from said manager.

2. A traffic monitoring system according to claim 1, wherein
said manager further comprises means for unloading said management application program.

3. A traffic monitoring system according to claim 1, wherein
each of said active monitors further comprises means for unloading said traffic analysis program in response to a request from said manager.

4. A traffic monitoring method comprising: a plurality of active monitors each tapping a physical line on a network and analyzing traffic; and a manager collecting analysis results from said active monitors, respectively, the method comprising the steps of:
allowing said manager to load and execute a management application program;
allowing said manager to request said active monitors to load a traffic analysis program;
allowing said active monitors to load and execute the traffic analysis program in response to said load request;
allowing said manager to request the active monitors to collect analysis results; and
allowing said active monitors to provide the analysis results to the manager in response to said request, respectively.

5. A traffic monitoring method according to claim 4, further comprising the steps of:
allowing said manager to request said active monitor to unload said traffic analysis program; and
allowing said active monitors to unload the traffic analysis program in response to said unload request.

6. A traffic monitoring method according to claim 5, further comprising a step of allowing said manager to unload the management application program from the manager itself.

7. A traffic monitoring system according to claim 4, wherein
said manager holds topology information concerned about the respective active monitors on a network, and manages traffic based on the analysis results collected from said respective active monitors and said topology information.

8. A traffic monitoring system according to claim 4, further comprising a step of changing operation parameters for the traffic analysis program, the traffic analysis program now being executed by each of the active monitors.

9. A traffic monitoring system according to claim 4, wherein
each of said active monitors identifies a packet and a protocol under control of said traffic analysis program.
